(19) United States
(12) Patent Application Publication
(10) Pub. No.: US 2013/0222191 A1
(43) Pub. Date: Aug. 29, 2013

(54) MOBILE APPARATUS AND METHOD OF MANUFACTURING THE SAME

(71) Applicant: Anwar Sathath, Ome-shi (JP)

(72) Inventor: Anwar Sathath, Ome-shi (JP)

(21) Appl. No.: 13/608,442

(22) Filed: Sep. 10, 2012

(30) Foreign Application Priority Data
Feb. 28, 2012 (JP) 2012-041291

(51) Int. Cl. H01Q 1/24; B05D 5/12

(52) U.S. Cl. 343/702; 427/58

(57) ABSTRACT

According to one embodiment, a mobile apparatus including a housing having a region in which a nonconductive member is formed in at least a portion of the region, an antenna installed in the region in which the nonconductive member is formed, and a conductive material containing paint applied on the nonconductive member in a direction to suppress output of a radio wave with respect to a position of the antenna.

### CROSS-REFERENCE TO RELATED APPLICATIONS

This application is based upon and claims the benefit of priority from prior Japanese Patent Application No. 2012-041291, filed Feb. 28, 2012, the entire contents of which are incorporated herein by reference.

### FIELD

Embodiments described herein relate generally to a mobile apparatus and a method of manufacturing the same.

### BACKGROUND

A mobile apparatus such as a tablet personal computer (tablet PC) often includes an antenna and transmitting/receiving circuit (to be referred to as a communication unit hereinafter) so as to be able to wirelessly connect to networks such as a local area network (LAN) and wide area network (WAN). The antenna and transmitting/receiving circuit transmits a high-power radio wave when transmitting information outside. This high-power radio wave has an adverse effect on human bodies. The amount of energy absorbed to a unit mass of a tissue for a unit time when a human body is exposed to a radio wave is called the specific absorption rate (SAR). By taking account of this adverse effect of a radio wave on human bodies, the tolerance of a local SAR is determined as an average value in a unit mass, for example, 10 g of an arbitrary tissue of a local portion of a human body in many countries. A wireless installation such as a mobile apparatus must be designed so as not to exceed the tolerance of this local SAR.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a front view showing an example of the arrangement of a mobile apparatus according to an embodiment;

FIG. 2 is an exemplary view showing an A-A′ section in FIG. 1;

FIG. 3 is a view for explaining an example of the use state of a tablet PC;

FIG. 4 is a graph showing the horizontally polarized wave of an antenna;

FIG. 5 is a graph showing the vertically polarized wave of the antenna; and

FIG. 6 is an exemplary view showing a C-C′ section in FIG. 2.

### DETAILED DESCRIPTION

Various embodiments will be described hereinafter with reference to the accompanying drawings.

In general, according to one embodiment, a mobile apparatus includes a housing and an antenna installed in the housing. The housing has a region in which a nonconductive member is formed in at least a portion of the region. The antenna is installed in the region in which the nonconductive member is formed. In addition, a conductive material-containing paint is applied on the nonconductive member in a direction to suppress the output of a radio wave with respect to the position of the antenna.

Also, a method of manufacturing the mobile apparatus according to the embodiment includes installing an antenna in a region of a housing, in which a nonconductive member is formed in at least a portion of the region, and applying a conductive material-containing paint on the nonconductive member in a direction that is required to suppress the output power of a radio wave with respect to the position of the antenna.

An example of the method of applying the conductive material-containing paint is to coat the nonconductive member in a direction to suppress the output power of a radio wave with the conductive material-containing paint. It is also possible to adhere an adhesive tape having a film of the conductive material-containing paint on the nonconductive member in a direction to suppress the output power of a radio wave.

When the conductive material-containing paint is applied on the nonconductive member in a direction to suppress the output power of a radio wave, the insulation properties of the nonconductive member decrease in the portion to which the conductive material-containing paint is applied. This makes it possible to decrease the output of a radio wave in that direction from the antenna. Consequently, communication can be performed without decreasing the overall transmission power of the antenna, while suppressing only the output of a radio wave in a predetermined direction so as not to exceed the tolerance of the local SAR.

Also, the application of the conductive material-containing paint as described above can easily be performed after the housing is designed. Therefore, even when the tolerance of the local SAR is found to be more or less exceeded after the housing is designed, the local SAR can easily be reduced without greatly changing the design.

Furthermore, the strength of the suppression of the output of a radio wave can be changed by changing the content of the conductive material in the conductive material-containing paint. This makes it possible to adjust the degree of the reduction of the local SAR.

The embodiment will be explained below with reference to the accompanying drawings.

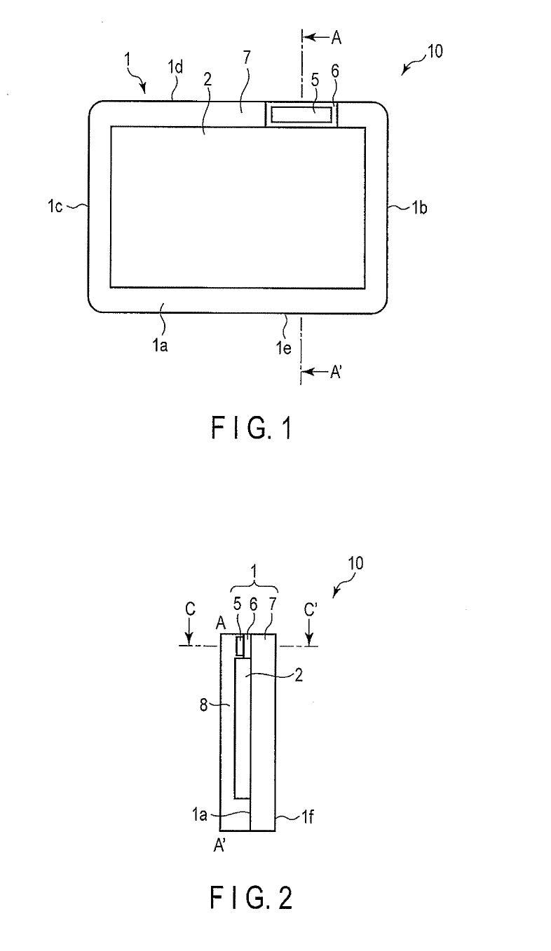

FIG. 1 is a front view showing an example of the arrangement of the mobile apparatus according to the embodiment.

Referring to FIG. 1, a tablet PC 10 includes a main body 1, a display 2, a communication unit formed in the main body 1 and including a nonconductive housing 7, a conductive material-containing paint film 6 formed on the nonconductive housing 7, and a transmitting antenna 5 installed on the conductive material-containing paint film 6, and a mask (not shown) for covering the main body 1 and display 2.

Also, the main body 1 includes a central processing unit (CPU), memory, and electric circuit board in the housing 7 having a rectangular parallelepiped shape. A front surface 1a of the main body 1 is a surface on which the display 2 is formed. Side surfaces 1b, 1c, 1d, and le are adjacent to the front surface 1a, and adjacent to each other. Side surfaces 1b and 1c oppose each other. Side surfaces 1d and le oppose each other.

A rear surface 1f opposes the front surface 1a.

In this embodiment, a nonconductive housing is used as the housing. However, it is also possible to use a combination of a nonconductive housing and conductive housing, provided that the nonconductive housing is positioned at the back of the antenna.

FIG. 2 is an exemplary view showing an A-A′ section in FIG. 1.

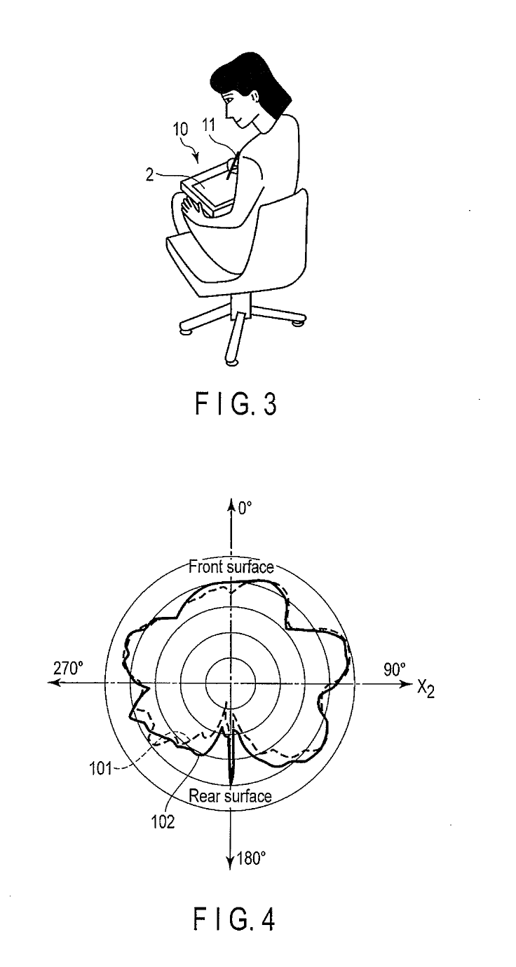

FIG. 3 is a view for explaining an example of the use state of the tablet PC.

Reference number 8 denotes a mask for covering the main body 1 and display 2.

The display 2 can display, for example, images generated by an internal signal processing circuit of the main body 1. The display 2 includes a touch panel with which an arbitrary operation can be performed by bringing a stylus pen 11 or the like into contact with the display area of the panel. The display 2 is attached on the front surface 1a of the main body 1. The display area of the display 2 has a rectangle whose aspect ratio is, for example, 4:3.

This mobile apparatus can suppress the output power of a radio wave from the rear surface 1f, because the conductive material-containing paint film 6 is formed on the rear surface 1f with respect to the transmitting antenna 5.

As shown in FIG. 3, the user often uses the tablet PC 10 on his or her lap while he or she is sitting in a chair. In this state, a portion of the human body closest to the transmitting antenna is the lap. Therefore, suppressing the output of a radio wave from the rear surface 1f of the tablet PC 10 among radio waves from the transmitting antenna 5 is useful in order to satisfy the tolerance of the local SAR of a radio wave radiated on the lap.

The communication unit can be connected to a predetermined network by wireless communication. The communication unit can be a communication module including the transmitting antenna 5, and a transmitting circuit and receiving circuit incorporated behind the display 2. The communication unit can be a means capable of being connected to networks complying with standards such as WLAN, WWAN such as Worldwide Interoperability for Microware Access (WiMAX), 3G, and LTE. The communication antenna 5 of the communication unit is placed near side surface 1d in the main body 1.

Note that FIG. 1 shows the tablet PC having a single housing in which the display unit is the apparatus main body, but the embodiment is not limited to this arrangement.

The embodiment need only be a mobile apparatus having a communicating function, and examples of a mobile apparatus like this are electronic apparatuses such as a tablet PC whose main body has a pivotal display unit, a notebook PC, a cellphone terminal, a personal digital assistant (PDA), and a portable game console.

Note also that the film of the conductive material-containing paint is formed on the nonconductive housing in FIG. 1. However, it is also possible to adhere an adhesive tape with the conductive material-containing paint, instead of the film of the conductive material-containing paint.

The adhesive tape with the conductive material-containing paint can be formed by coating, with the conductive material-containing paint, one surface of a resin tape whose other surface is coated with an adhesive agent, and drying the conductive material-containing paint.

As the material of the resin tape, it is possible to use, for example, an insulating film such as a polycarbonate film or vinyl chloride film.

### EXAMPLES

### Example 1

As a conductive material-containing paint for suppressing the radiation pattern of an antenna in a tablet PC having the same arrangement as that shown in FIG. 1, a urethane-acrylic resin-based paint containing 8.1 wt % of an Al powder was prepared, applied on a nonconductive housing, and dried, thereby forming a 15- to 25-μm-thick conductive material-containing paint film.

The antenna radiation patterns of the obtained tablet PC were measured.

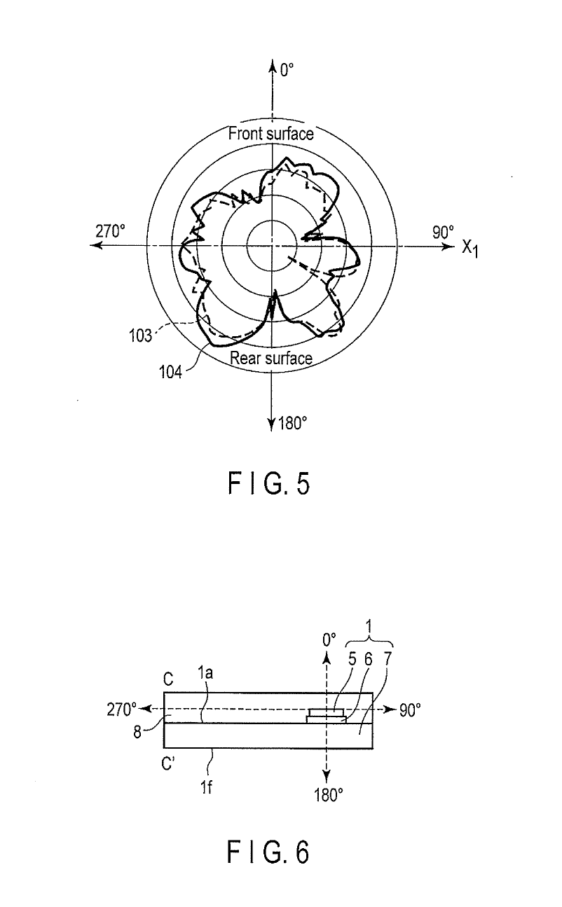

FIGS. 4 and 5 respectively show the vertically polarized wave and horizontally polarized wave of the obtained radiation patterns.

Also, FIG. 6 is an exemplary view showing a C-C′ section in FIG. 2.

This C-C′ section includes a horizontal surface as the measurement standard of the radiation patterns shown in FIGS. 4 and 5. 0, 90, 180, and 270° in FIGS. 4 and 5 are the same directions as those of 0, 90, 180, and 270° in FIG. 6.

### Comparative Example 1

For comparison, the antenna radiation patterns of a tablet PC having the same arrangement as that shown in FIG. 1 except that no conductive material-containing paint film was formed were measured.

In FIG. 4, a radiation pattern 101 indicates the measurement result of Example 1, and a radiation pattern 102 indicates the measurement result of Comparative Example 1.

In FIG. 5, a radiation pattern 103 indicates the measurement result of Example 1, and a radiation pattern 104 indicates the measurement result of Comparative Example 1.

As shown in FIGS. 4 and 5, in the tablet PC of Example 1, it was possible to more or less decrease the insulation properties of the nonconductive housing by applying the conductive material-containing paint on the nonconductive housing in a direction to suppress the output of a radio wave with respect to the position of the antenna, i.e., in the direction of the rear surface of the tablet PC. When using the tablet PC of Example 1 as shown in FIGS. 4 and 5, therefore, it was possible to reduce the output of a radio wave, particularly, the output of the horizontally polarized wave near the direction of 180° on the rear surface side of the tablet PC, when compared to the tablet PC of Comparative Example 1.

Note that a tablet PC can be obtained as follows instead of directly coating the nonconductive housing with the above-described, resin-based paint. That is, an adhesive tape with a conductive material-containing paint is formed by forming a 15- to 25-μm-thick film of the conductive material-containing paint by coating, with this paint, one surface of a polycarbonate insulating film (such as Polyca-Ace® [manufactured by Sumitomo Bakelite]) having an adhesive layer on the other surface, and adhering the obtained adhesive tape on the nonconductive housing. A radio wave absorbing material can also be used instead of the conductive material-containing paint.

Consequently, it was possible to reduce the output of a radio wave in the direction of the rear surface as in Example 1, when compared to the tablet PC of Comparative Example 1.

As is apparent from Example 1, the mobile apparatus according to the embodiment can reduce the output of a radio wave in a direction to suppress the output of a radio wave, by only applying the conductive material-containing paint on the nonconductive member in the direction to suppress the output of a radio wave with respect to the position of the antenna. Accordingly, even when the tolerance of the local SAR is found to be more or less exceeded after the housing is designed, the local SAR can easily be reduced without greatly changing the design.

Note that the content of the metal powder in the conductive material-containing paint in the above-mentioned example is an example, so the metal powder content can be changed as long as the output of a radio wave in a predetermined direction can be reduced so as not to exceed the tolerance of the local SAR.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A mobile apparatus comprising:
a housing comprising a region in which a nonconductive member is formed in at least a portion of the region area;
an antenna installed in the region in which the nonconductive member is formed; and
a conductive material-containing paint applied on the nonconductive member in a direction to suppress output power of a radio wave with respect to a position of the antenna.

2. The apparatus according to claim 1, wherein the direction to suppress output power of a radio wave is a direction of a human body.

3. The apparatus according to claim 1, wherein the housing further includes a display surface, and the direction to suppress output power of a radio wave is a direction of a rear surface with respect to the display surface.

4. A mobile apparatus manufacturing method comprising installing an antenna in a region of a housing, in which a nonconductive member is formed in at least a portion of the region, and applying a conductive material-containing paint on the nonconductive member in a direction to suppress output power of a radio wave with respect to a position of the antenna.

5. The method according to claim 4, wherein the direction to suppress output power of a radio wave is a direction of a human body.

6. The method according to claim 4, wherein the housing further includes a display surface and the direction to suppress output power of a radio wave is a direction of a rear surface with respect to the display surface.
